(19) United States
(12) Patent Application Publication
(10) Pub. No.: US 2017/0182926 A1
(43) Pub. Date: Jun. 29, 2017

(54) Boat Trailer & Method for Securing Boat Thereto

(71) Applicant: Brooks Rice, Fayetteville, AR (US)

(72) Inventor: Brooks Rice, Fayetteville, AR (US)

(21) Appl. No.: 14/983,189

(22) Filed: Dec. 29, 2015

(51) Int. Cl. B60P 3/10

(52) U.S. Cl. CPC B60P 3/1066; B60P 3/1058

(57) ABSTRACT

Disclosed is a boat trailer incorporating a pivoting mechanism wherein a stern capture flange serves to secure the stern of the boat so as to prevent the boat from sliding off of the rear of the boat trailer. Specifically, the invention utilizes the weight of the boat itself to trigger the fulcrum action of the pivoting roller mechanism, wherein the boat is mechanically seated in place via the inward contact face of the stern capture flange. Also disclosed is a method for securing a boat to a trailer having a pivoting roller mechanism.

### GOVERNMENTAL RIGHTS

None.

### BACKGROUND OF THE INVENTION

The present invention relates to boat trailers and constitutes a novel pivot actuating mechanism with flange for securing a boat to a boat trailer.

There are commercially available methods for securing a boat to a trailer. One method is to first secure the bow of the boat to the boat trailer using a winch mechanism from which a strap and hook extend to secure the bow of the boat to the trailer. As part of this method, a user then secures the stern of the boat to the rear of the trailer using tie-down ratcheting straps. Typically there are corresponding anchor points on both the stern of the boat and trailer.

There are a number of problems associated with existing means of securing a boat to its trailer. First, over time some strapping means become worn. This requires the user to replace the strapping means in order to ensure that the boat is securely attached to the boat trailer. Second, these strapping means are not suitable for all types of boats and trailers; were a boat to lack a suitable anchor point on the stern the user would lack the point to which a tie-down ratcheting strap could fasten. Third, users may neglect to use the tie-down ratcheting straps properly (or at all). When this occurs, the boat may bounce off the trailer or slide side-to-side while traveling down the road thereby creating a very dangerous condition.

Today many trailers have supporting members that run longitudinally along the axis of the boat to nestle the boat into a secure position on the trailer. Some are designed specifically to fit the hull of the particular boat. These longitudinal supporting members are known as bunks, and the bunks are preferentially adjustable to accommodate a boat hull shape. In order to facilitate loading of the boat on the trailer, some trailers incorporate both bunks and roller type elements. This makes loading easier; however, none of the currently available devices, bunks or rollers, serve the dual purpose of stabilizing the boat and securing the boat to the boat trailer.

U.S. Pat. No. 4,893,828 discloses a roller and bunk assembly having a plurality of rollers disposed on either side of the longitudinal axis of the frame. The rollers in such patent serve only to allow the boat to be loaded onto the boat trailer. Such disclosed roller assembly provides no mechanism by which the boat is securely held so as to prevent it from sliding off the back of the trailer or from side-to-side. The present disclosure solves many of the foregoing problems.

### BRIEF SUMMARY OF THE INVENTION

Disclosed is a boat trailer incorporating a unique pivot-roller mechanism that, when used in conjunction with longitudinal bunk supports, preferentially serves to secure both the body and stern end of the boat so as to prevent the boat from sliding side-to-side and backwards off the rear of the boat trailer while the boat is being transported. The invention elegantly uses the weight of the boat itself to trigger a fulcrum action upon a unique pivot-roller mechanism, wherein the boat is seated in proper trailer placement using longitudinal bunk supports and is additionally secured in proper trailered position using an elevated stern capture flange that may additionally have rollers incorporated as part of the flange. Also claimed is a method for securing a boat using a pivoting roller mechanism having a stern capture flange.

### BRIEF DESCRIPTION OF THE DRAWINGS

FIG. 1 is a perspective view of the Boat Trailer.

FIG. 2 is a side view of the Boat Trailer.

FIG. 3 is a top view of the Boat Trailer.

FIG. 4 is a cut away side view of the Boat Trailer.

FIG. 5 is a cut away side view of the Boat Trailer.

FIG. 6 is a cut away side view of the Boat Trailer.

FIG. 7 is a cut away side view of the Boat Trailer.

FIG. 8 is a cut away side view of the Boat Trailer.

FIG. 9 is a cut away side view of the Boat Trailer.

### LISTING OF COMPONENTS

101—Towing Coupler Assembly

103—Tongue

105—Frame

107—Boat Winch

109—Front Cross Member

111—Medial Cross Member

113—Rear Cross Member

115—Pivot Roller Mechanism Assembly

117˜Pivot Roller Mechanism Bracket Mount

119—Pivot Roller Mechanism Bracket

121—Pivot Bolt

123—Pivot Roller Mechanism

124—Stern Flange

125—Roller

127—Bow Longitudinal Bunk

129—Stern Longitudinal Bunk

131—Wheel & Axle Assembly

133—Fender

135—Fender Storage Box

### DETAILED DESCRIPTION OF THE INVENTION

### First Preferred Embodiment

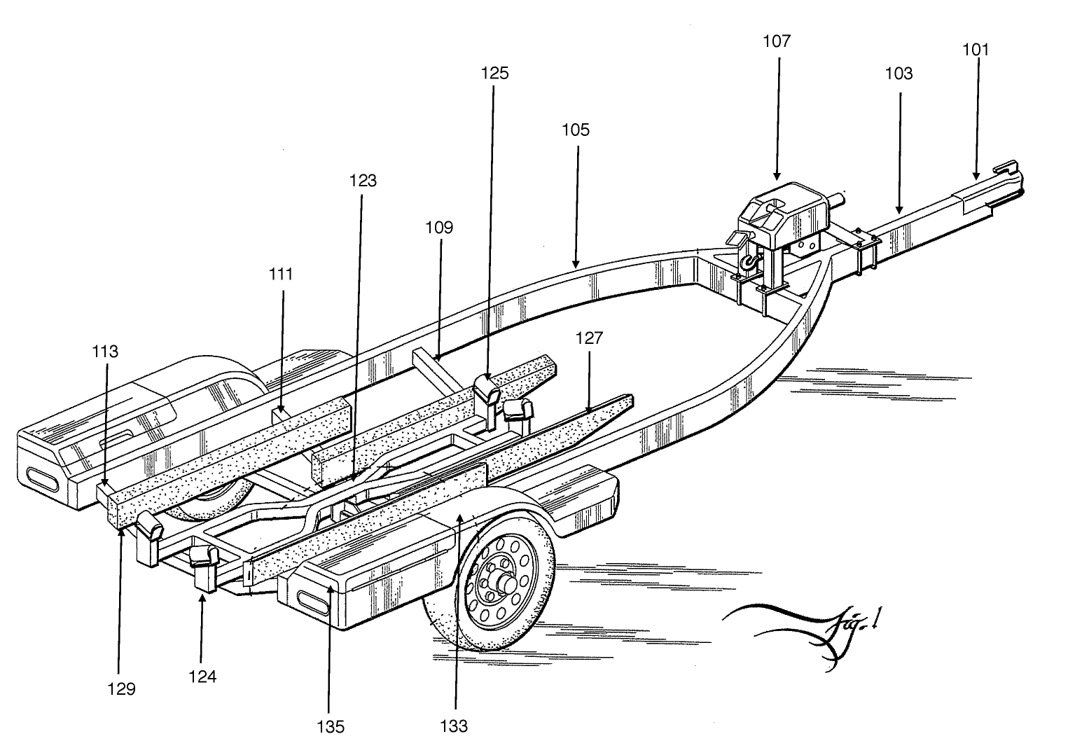

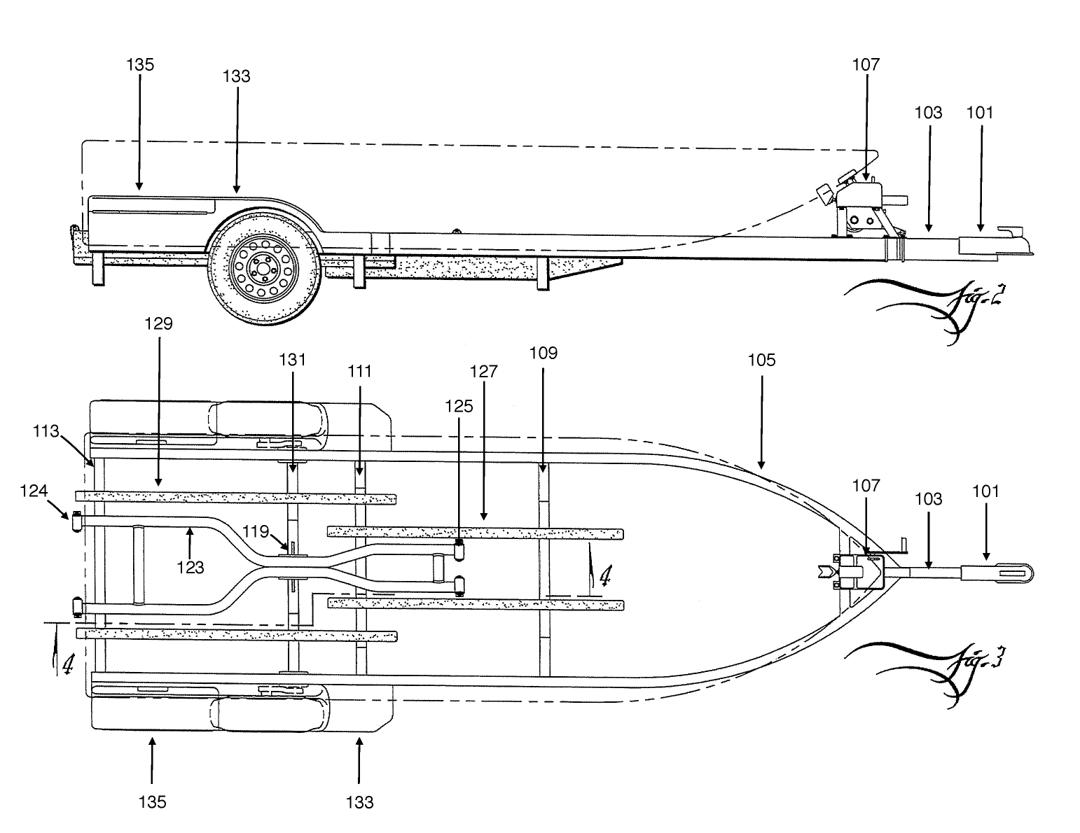

In this first preferred embodiment, depicted in FIG. 1, a unique boat trailer is comprised of a towing coupler assembly 101, a tongue 103, a frame 105, longitudinal bunks (127, 129), cross members (109, 111, 113), a wheel and axle assembly 131, and fenders 133. Additionally, the trailer contains a novel pivoting roller mechanism assembly 115 having a unique stern flange 124, which serves to secure and prevent the boat from sliding off of the rear of the boat trailer. As shown in FIG. 1, the stern flange 124 preferentially incorporates rollers in this first preferred embodiment.

The trailer has a front (bow) and a back (stern) with port (left) and starboard (right) sides. As shown in FIG. 3, the tongue 103 and frame 105 combine to form a skeleton structure to which the other elements of the trailer attach. The tongue 103 extends transversely along the longitudinal centerline of the frame 105 and connects to the frame 105 at the bow end of the trailer, extending to the stern therefrom. The tongue 103 is industry typical. The frame 105 is comprised of at least two structural elements that are spaced apart and are connected at the bow end, forming the nose of the trailer.

As shown in FIGS. 1 and 3, front cross members 109, medial cross members 111, and rear cross members 113 are connected to frame 105. The various cross members (109, 111, 113) are formed so as to allow for a fulcrum-like movement of the pivot roller mechanism assembly 115 and serve as attachment points for the forward 127 and rear 129 longitudinal bunks.

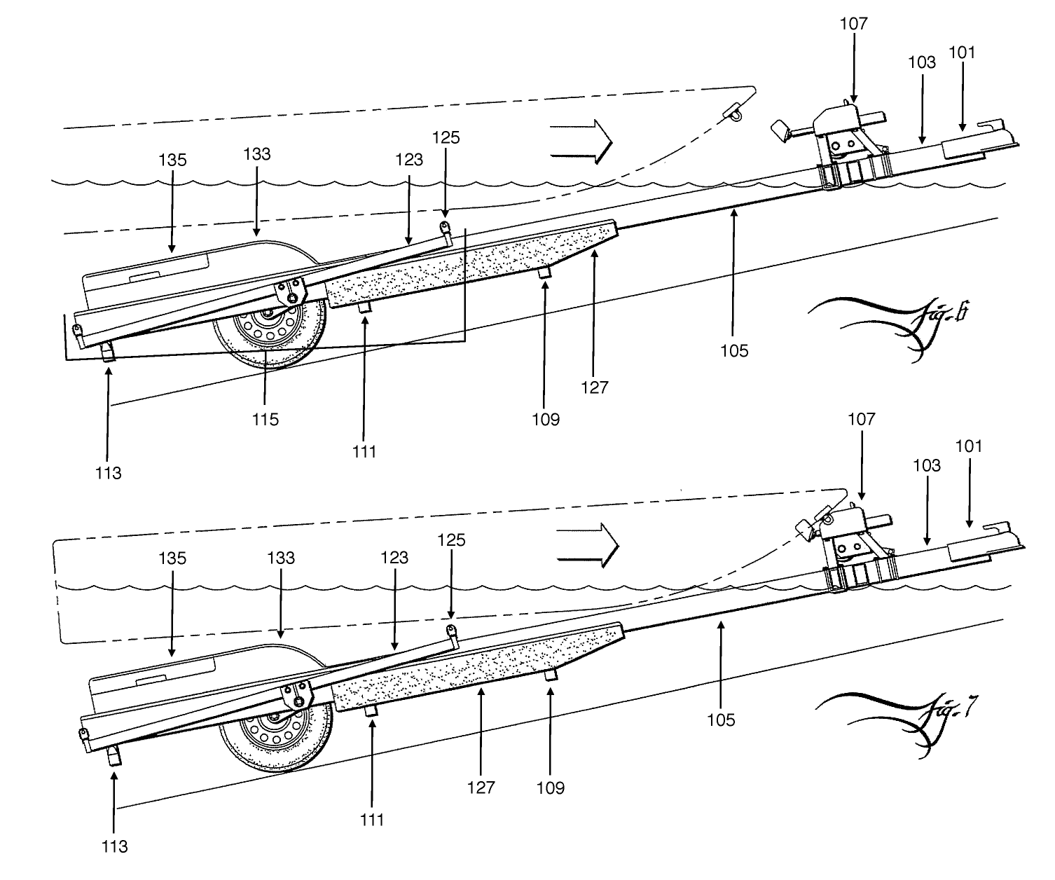

The bow region longitudinal bunks 127 may be preferentially connected to the front 109 and medial 111 cross members and are spaced apart and oriented so as to allow for proper the placement of the pivot roller mechanism assembly 115, as depicted in FIG. 6. The stern longitudinal bunks 129 are preferentially connected to medial 111 and rear 113 cross members. As with the bow longitudinal bunks 127, the stern longitudinal bunks 129 allow for proper placement of the pivot roller mechanism assembly 115, as depicted in FIG. 6. The longitudinal bunks (127, 129) support the hull of the boat while the boat rests upon the trailer assembly.

As depicted in FIG. 6, the pivot roller mechanism assembly 115 comprises a pivot roller mechanism bracket mount 117, the pivot roller mechanism bracket 119, a pivot bolt 121, a pivot roller mechanism 123, a stern flange 124, and one or more rollers 125.

Having a first and second end, the pivot roller mechanism bracket mount 117 is affixed to the wheel and axle assembly 131 or to the cross members (109, 111). The width of the pivot roller mechanism bracket mount 117 may correspond to a portion of the pivot roller mechanism 123 to allow the proper mounting of the pivot roller mechanism bracket 119 and motion of the pivot roller mechanism 123.

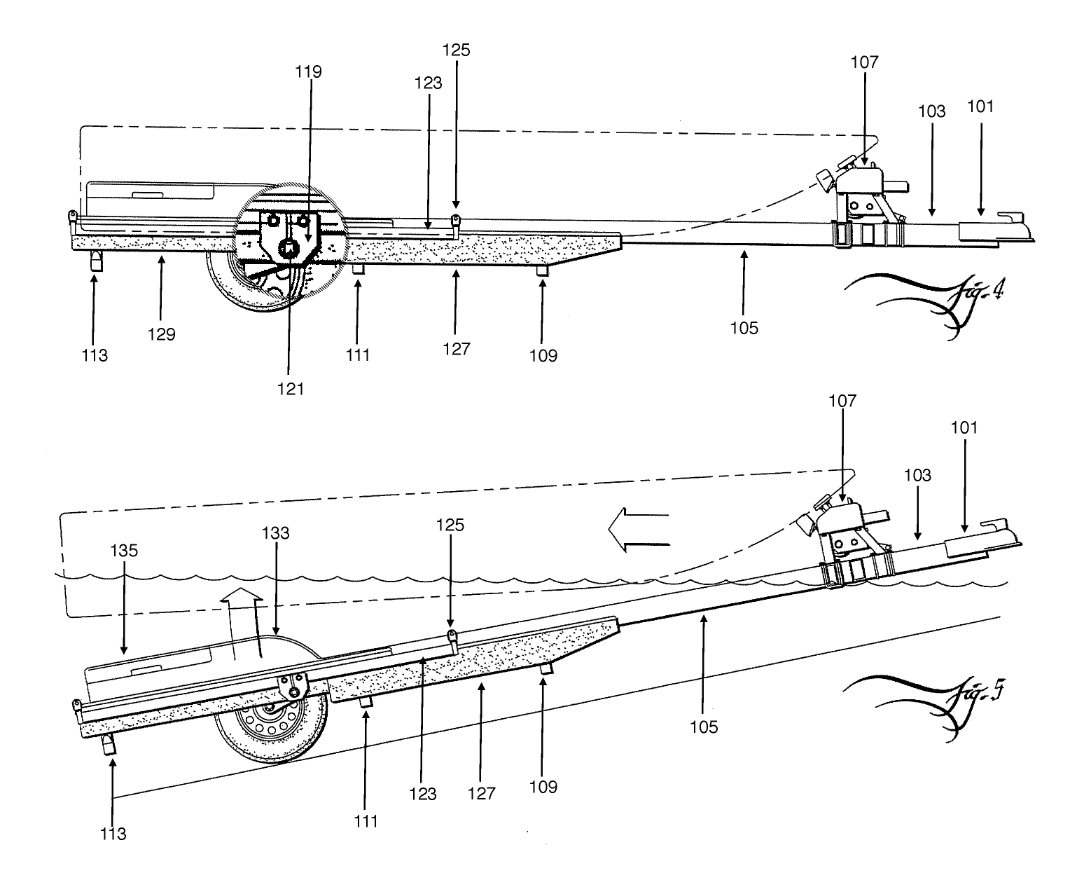

As shown in FIG. 4, a pivot bolt 121 or other connective means pivotally connects the pivot roller mechanisms brackets 119. Such pivot bolt 121 or other connective means serves as an axis on which the pivot roller mechanism 123 may preferentially pivot.

Pivot roller mechanism bracket 119 attaches to the pivot roller mechanism bracket mount 117, each having an upper and lower portion. FIG. 4 depicts the lower portion of each bracket 119 as having a hole through which a pivot bolt 121 extends and connects each bracket 119, thereby creating an axis on which the pivot roller mechanism 123 may preferentially move along a range of positions.

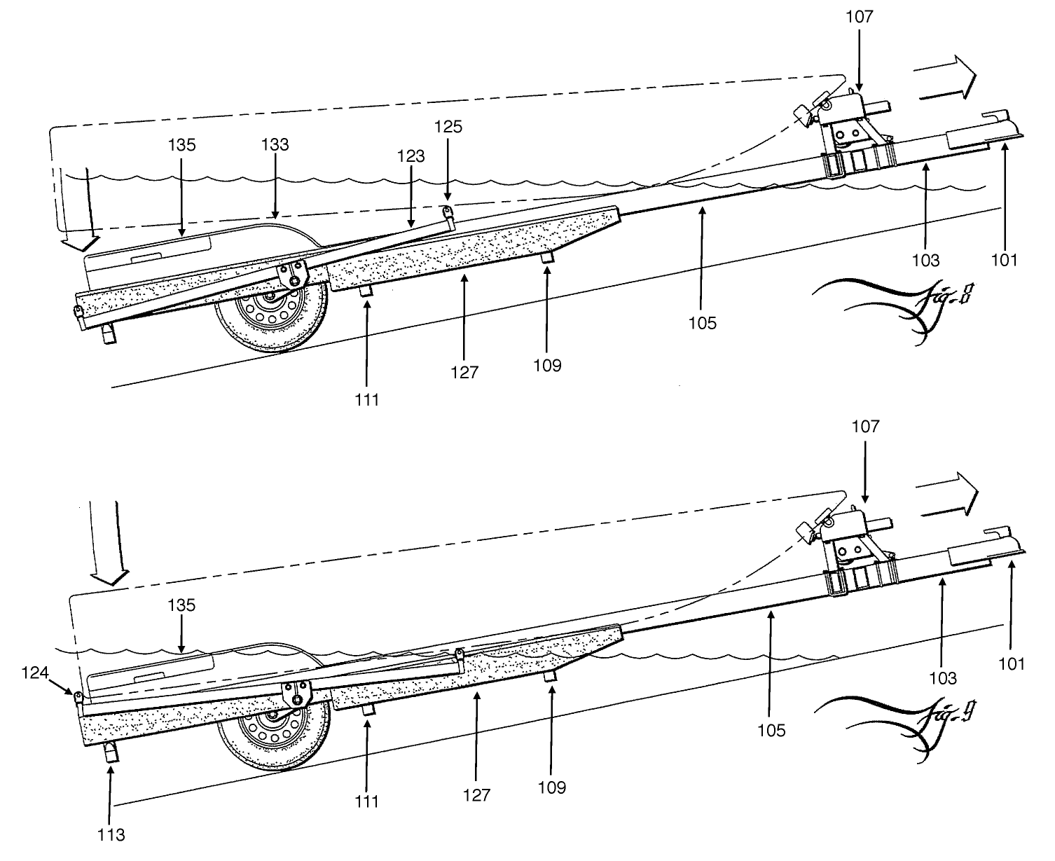

The pivot roller mechanism 123, shown in FIG. 5, has a bow end and stern end. Rollers 125 mount to bow end. Stern capture flange 124 mounts to the stern end of the pivot roller mechanism 123. Pivot roller mechanism 123 pivots about the axis of the pivot bolt 121 such that, as shown in FIGS. 6-9, when a boat is placed upon the trailer, the weight of the boat triggers a fulcrum-like force upon the pivot roller mechanism 123, thereby forcing the stern capture flanges 124 to seat properly capture the stern of the boat and secure the boat from moving off the trailer.

Attached at the tongue-frame juncture is a boat winch 107, or other securing means, which is used for securing and loading or unloading a boat onto or off the trailer. The boat winch 107 may be of any type typical to the industry and is attached to the frame 105 and tongue 103 via any convenient manner.

In this first preferred embodiment, as shown in FIG. 6, the boat winch 107 is preferentially attached to the frame 105 near the tongue 103. Further, in this first preferred embodiment, the wheel and axle assembly 131, fenders 133, and fender storage boxes 135 are also attached to the frame 105 near the rear cross member 113. The fenders 133 and fender storage boxes 135 are attached to either side of the stern end of the frame 105.

### Second Preferred Embodiment

As shown in FIGS. 6-9, this second preferred embodiment discloses a method of securing a boat to the trailer wherein the boat trailer incorporates a mechanism such as a pivot roller mechanism assembly 115, as disclosed in the first preferred embodiment.

Starting from a first position whereby the trailer is partially submerged into the water, the user begins to navigate a boat onto the trailer. As the user navigates the boat into a second position upon the trailer, the boat hull actuates the front rollers 125 of the pivot roller mechanism 123, which assist in the proper seating of the boat hull into proper alignment on the boat trailer. As the boat is navigated into a final resting position, the boat stern moves forward beyond the stern capture flange 124. The weight of the boat applies pressure to the pivot roller mechanism 123 thereby actuating the stern capture flange 124 into a final position that captures the boat hull. This process secures the boat on the trailer. In order to remove the boat, the reverse process is followed; namely, partially submerging the boat trailer into water provides lift to the boat thereby reducing the weight applied to the pivot roller mechanism 123 and permitting the boat to move beyond the stern capture flange 124 and be freed from the trailer.

I claim:

1. A boat trailer, comprising:
a frame having a bow and stern end, elongated side members, a rear cross member to form the stern end of the frame, and a tongue forming the bow end;
cross members connecting to the elongated frame members;
an axle secured to the frame;
a pivoting roller mechanism assembly being attached to the axle or cross members; the pivot roller mechanism having a first and second end with rollers on the first end and a stern capture flange on the second end, wherein the pivot roller mechanism operatively engages with the hull of the boat and the stern capture flange engages with the stern of the boat to secure and prevent a boat from sliding off the end of the trailer; and
a plurality of stationary bunks for supporting the hull of the boat.

2. A pivot roller mechanism assembly for a boat trailer, comprising:
a pivot roller mechanism bracket mount having a first and second end and a hole extending through the center thereof, wherein the pivot roller mechanism bracket mount is attached to a boat trailer;
a pair of pivot roller mechanism brackets connected by a cylindrical pivot bolt;
a cylindrical pivot bolt having a first and second end extending through the hole in the pivot roller mechanism bracket mount, wherein the first and seconds are attached to the pivot roller mechanism brackets; and
a pivot roller mechanism having a first and second end with a roller on the first end and a stern capture flange on the second end, wherein the rollers operatively engage with the hull of the boat and the stern capture flange engages with the stern of a boat to secure and prevent a boat from sliding off the end of a trailer.

3. The pivot roller mechanism assembly of claim 2, wherein the pivot roller mechanism bracket mount is directly connected to a wheel and axle assembly.

4. A method of securing a boat to a trailer comprising the steps of:
navigating a boat onto a partially submerged trailer into a first, position, wherein the boat engages a pivot roller mechanism having a first and second end, with the first end of the pivot roller mechanism comprising rollers and the second end comprising a stern capture flange;
navigating a boat into a second position, wherein the boat applies pressure to the rollers of the first end of the pivot roller mechanism, thereby pivoting the pivot roller mechanism and applies force to the stern capture flange;
navigating a boat into a final position, wherein the stern capture flange mechanically captures the stern of the boat and secures the boat to the trailer.
